(19) United States
(12) Patent Application Publication
(10) Pub. No.: US 2005/0008428 A1
(43) Pub. Date: Jan. 13, 2005

(54) Attachment and articles using same

(75) Inventors: Sameer Desai, Lake Orion, MI (US); Norman Woodworth, Lake Orion, MI (US)

Correspondence Address: Valeo Inc, 4100 North Atlantic Boulevard, Auburn Hills, MI, 48326, US

(73) Assignee: Valeo Inc

(21) Appl. No.: 10/642,962

(22) Filed: Aug. 14, 2003

Related U.S. Application Data
(60) Provisional application No. 60/485,895, filed on Jul. 9, 2003.

(51) Int. Cl. F16B 1/00

(52) U.S. Cl. 403/13

(57) ABSTRACT

There is disclosed an attachment suitable for attaching a first component of an article to a second component of the article. The attachment preferably includes a flange portion extending from the first component and a slot or slot tab or stop wall or locator post extending from the second component. The assembled components form an assembly which reduces or restricts vibration or movement of the components in specific directions

### FIELD OF THE INVENTION

The present invention relates generally to an assembly of components and affixing means such as an attachment for attaching a first component to a second component. The present invention also relates to a method of attaching a first component to a second component employing the affixing means of the present invention. More particularly, the present invention relates to attachment components for attaching at least one heater exchanger to an attachment component of elements such as a shroud or another heat exchanger for forming a heat exchanger assembly, and a method for attaching using such attachments.

### BACKGROUND OF THE INVENTION

For many years, industry has been concerned with designing improved attachments for various articles and applications. Particularly in vehicle cooling systems, heat exchangers may be affixed together as a module or as a multiple heat exchanger assembly. The industry has designed attachments suitable for attaching a heat exchanger to a component such as a shroud, a wall, another heat exchanger, a front end structure of an automotive vehicle or the like to form a heat exchanger assembly, which may be employed in articles of manufacture such as automotive vehicles. Many such assemblies have, as affixing means, fasteners such as screws, metal clips or nuts mounted to adjacent heat exchangers. Such fasteners have often been composed of carbon steel subject to ‘red rust’ or corrosion, or have had to be plated or made of stainless steel to prevent or retard costly corrosion. In the case of some heat exchanger to exchanger assemblies, in order to decrease the number of affixing means, some assemblies have included lower mounting “J” shaped brackets or the like on, for example, the second heat exchanger, that have reduced, in some interests, the amount of fasteners affixing means up to about 50%.

Other methods of affixing heat exchangers, for example, either integral to plastic end tanks or using plastic flexible members may be found in the prior art. In particular, affixing means wherein a flexible hook member ‘traps’ the bracket of an adjacent exchanger by being hooked over the edge of the bracket, with heat exchanger faces approximately normal to the vehicle air stream and approximately vertical to the ground have been described. U.S. Pat. Nos. 5,657,817, 6,158,500 and 5,996,684 describe flexible hook members of this style.

One of the problems with heater exchange assemblies of the sort described above is that such assemblies are often, of necessity, mounted to the vehicle frame through isolates to cushion the effects of harsh differential inertia movements relative to the vehicle frame. The assemblies are subject to high frequency/low inertia vibration movements, as well as harsh low frequency/high inertia ones. Hook type members, particularly those attaching to the edge of a mating bracket or the like are, therefore, at risk of being dislodge and could potentially cause disassembly of the attached assemblies during normal driving of the vehicle.

### OBJECTS OF THE INVENTION

It is an object of the present invention to provide assemblies, and, in particular, heat exchanger assemblies, that avoid use of screw and clip or nut fasteners, to the maximum amount possible, to affix components. It is a further object of the present invention to avoid affixing means that might be dislodged more easily during normal driving, and that do not require additional parts to restrict movement. It is a further object of the invention to provide a method for attaching a first component such as a heat exchanger to a second component such as a heat exchanger employing the affixing means of the present invention.

### SUMMARY OF THE INVENTION

The present invention provides for a robust mounting that allows the assembly of multiple components, and, in particular, heat exchangers, without, necessarily, the use of fasteners. The present invention further provides for reduced cost assemblies due to decreased parts and increased life-span of affixing over technologies currently present in the industry. The present invention further provides for heat exchangers affixed to other exchangers whereby the bracket of the adjoined heat exchanger is completely ‘submerged’ or ‘captured’ by the first heat exchanger in vehicle front to back movements so as not to be subject to dislodgement or other detachment during vibration and differential harshness conditions of normal vehicle driving. The present invention further provides for assemblies made of materials that are ‘non-corrosive’ or ‘non-metallic’ thereby avoiding prior art problems such as ‘red rust’ or ‘corrosion’ at attachment or affixing points of the components. In addition, the present invention solves present problems by providing tight packaging and an easily assembled module that can withstand all normal inertial loading placed upon it under normal driving conditions.

According to one aspect of the invention, there is disclosed an attachment for attaching a first component of an article to a second component of the article. As an example, the attachment may be employed for attaching a first heat exchanger to a component such as a shroud, a wall, another heat exchanger, a front end structure or module of an automotive vehicle or the like for assisting in forming a heat exchanger assembly. The attachment may preferably be in two parts, a first attachment component and a second attachment component. According to one embodiment, the attachment includes flange members. In preferred embodiments of the present invention, a heat exchanger assembly, comprises a first attachment component including slot tab, a flexible member, such as ‘flex’ or ‘bayonet’ member or the like. Also preferred are embodiments which have flexible members with or without a ledge and with or without an alignment element such as a ‘post’ or ‘locator post’ combination; a second attachment component, including a mating bracket with flange combination; wherein the first attachment component is approximately parallel to the second attachment component and wherein the bracket is aligned with the opening formed by the slot walls, post or locator post of the first heat exchanger component and assembled using a sliding motion. More preferred are embodiments where the first attachment component flexible member includes a ledge, more preferred, a snapping ledge.

Also preferred are embodiments wherein the flange of the second attachment component is captured under the slot tab of the first attachment component. Also preferred are embodiments wherein the first attachment component further includes a ‘back up’ or ‘accessory’ hole for a screw as a secondary support. Even more preferred embodiments provide for a heat exchanger assembly wherein one or more of the attachment components engage another component by snapping in. Also more preferred is a heat exchanger assembly wherein two or more of the attachment components engage other components by snapping in. In even more preferred embodiments the heat exchanger assembly comprises a first attachment component including a slot wall, slot tab, locator post, stop wall, stop edge, flex finger or bayonet and a ledge combination; and a second attachment component, including a mating bracket with flange combination; wherein the first attachment component is approximately parallel to the second attachment component and wherein the bracket is aligned with the opening or open area formed by the slot walls of the first heat exchanger component, and eventually a locator post. In even more preferred embodiments, the heat exchanger assembly components are assembled using a sliding motion.

### BRIEF DESCRIPTION OF THE DRAWINGS

The features and inventive aspects of the present invention will become more apparent upon reading the following detailed description, claims and drawings, of which the following is a brief description:

FIG. 1 is a perspective view of a heat exchanger assembly employing an attachment in accordance with an exemplary aspect of the present invention;

FIG. 2a is another perspective view of a bracket which provides affixing means via snap attachment in accordance with an exemplary aspect of the present invention;

FIG. 2b is another perspective view of an affixing means with slot tabs, bayonet or flexible finger with a ledge, locator post, backup screw hole, stop wall, stop edge and slot wall in accordance with an exemplary aspect of the present invention;

FIG. 2b-1 is another perspective view of an affixing means with slot continuous flange, bayonet or flexible finger with a ledge, locator post, backup screw hole, stop wall, stop edge and slot wall in accordance with an exemplary aspect of the present invention;

FIG. 2c is another perspective view of an affixing means with slot tabs, bayonet or flexible finger with a ledge, slot wall, stop edge and stop wall in accordance with an exemplary aspect of the present invention;

FIG. 3a is another perspective view of a bracket which provides affixing means without snap attachment in accordance with an exemplary aspect of the present invention;

FIG. 3b is another perspective view of an affixing means with slot tabs, bayonet or flexible finger without a ledge, locator post, stop wall and slot wall in accordance with an exemplary aspect of the present invention;

FIG. 3c is another perspective view of an affixing means with slot tabs, bayonet or flexible finger without a ledge, stop wall and slot wall in accordance with an exemplary aspect of the present invention;

FIG. 4a is another perspective view of a heat exchanger assembly affixing means between two heat exchangers with snap attachment and using locator post in accordance with an exemplary aspect of the present invention;

FIG. 4b is another perspective view of a heat exchanger assembly affixing means between two heat exchangers with snap attachment and without the use of locator post in accordance with an exemplary aspect of the present invention;

FIG. 4c is another perspective view of a heat exchanger assembly affixing means between two heat exchangers without snap attachment in accordance with an exemplary aspect of the present invention.

### DETAILED DESCRIPTION OF THE INVENTION

The present invention is predicated upon providing an improved affixing means and method for attachment. It is contemplated that an affixing means such as an attachment, snap or a ‘slide and snap’ attachment may be employed in a variety of articles of manufacture including, without limitation, electronic articles, buildings, furniture, recreational articles, manufacturing articles or the like. In preferred embodiments, the affixing means may be used with multiple assemblies, particularly where stacked assemblies are used in areas of dynamic vibration, e.g. fan shroud assemblies attached to an adjacent heat exchanger. In other preferred embodiments, the affixing means may be used to mount oil coolers face to face with an adjacent heat exchanger or heat exchanger core. In still other preferred embodiments, sensing devices may also be assembled using the affixing means to heat exchangers on the tank, core or both areas. The affixing means may also be used with multiple screen assemblies in a filter system or multiple shelving systems that might require a more robust mounting. Other preferred embodiments include vehicle sub-frames mounting several components in sub-assembly prior to mounting on a vehicle, in particular, affixing means for attaching elements such as front end structures components of a vehicle. In more preferred embodiments, affixing means comprise plastic or plastic-like materials that can be part of molded features to trap, for example, a flange member to affix the component to the front end structure.

The affixing means, and, in particular, an attachment such as the snap or slide and snap attachment, however, is particularly suitable for use in heat exchanger assemblies and even more particularly, the attachment is suitable for use in heat exchanger assemblies of vehicles and, particularly, automotive vehicles. Thus for convenience, the illustrated attachments are applied to heat exchanger assemblies, however, the skilled artisan will appreciate that the assemblies may be adapted for use in other articles as well.

As used herein the term “heat exchanger” is intended to include any system configured for exchanging heat to or from one or more fluids that are preferably flowing within or about the system. Thus, a heat exchanger may be an oil cooler, a water cooler, an air heater, a condenser, a fan shroud, a radiator, a front end structure to carry engine cooling components or the like.

In preferred embodiments, the heat exchanger assembly has a first exchanger attachment component which includes slot wall, slot-tab or slot continuous flange, flex finger with a ledge combination, alignment element such as a locator post, stop wall and a stop edge. Slot tabs may be discrete and described as ‘slot tab’ or ‘tabs’ or continuous such as a slot continuous tab or flange. The second heat exchanger attachment component preferably includes a flange on a mating bracket which, when assembled with the first heat exchanger attachment component will be ‘trapped’ or ‘restricted’ in movement under the tab or continuous flange of the first heat exchanger attachment component and the flex finger ledge of the first exchanger attachment component engages to the upper part of the window in the mating bracket A flex finger ledge prevents vibration movement in one of the ‘cross car’ or left to right direction, a stop edge prevents the remaining cross car movement, a stop-wall restricts vibration in one of the vehicle front to back movement, the slot tab restricts vibration in one of the vehicle front to back movement, the locator post restricts top to bottom or vertical vibration and flex finger creates preload on the second component which is bracketed to prevent any looseness in the system. When the ledge snaps to the opening of the bracket it is a snapped attachment and when there is no ledge in the attachment then it is non-snapped attachment.

Also in preferred embodiments, the flexible member, such as the flex finder, with or without a ledge, is aligned to provide preload to the bracket of the second component against the slot tab or continuous tab or flange.

In preferred embodiments, various elements are available to restrict or prevent motion in a direction. In more preferred embodiments, the stop edge prevents over-travel or excessive sliding. Also in more preferred embodiments, the stop wall prevents over flexing of the flex member or bayonet. In more preferred embodiments, and leading edges allow smooth engagement of the flexible member with slot tabs. In particularly preferred embodiments, a snapped attachment combination in accordance with the present invention restricts movement in at least 2 directions. In other particularly preferred embodiments, a snapped attachment combination in accordance with the present invention restricts movement in at least 4 directions.

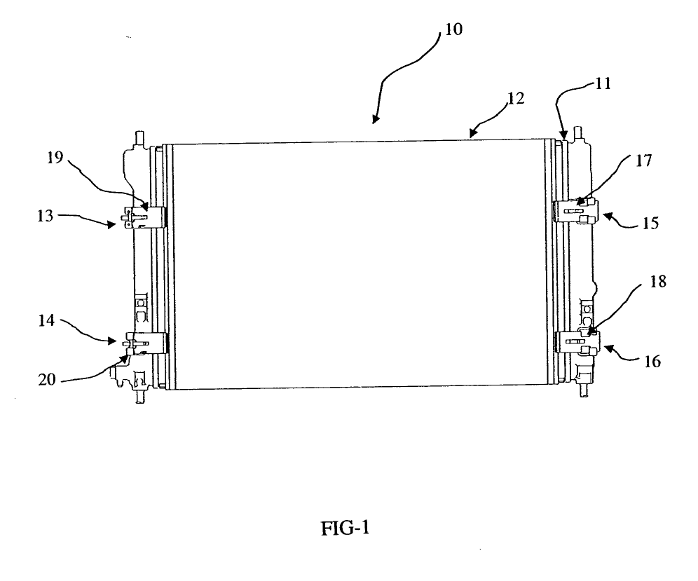

Referring to FIG. 1, there is illustrated an assembly 10, which is shown as heat exchanger 11 and heat exchanger 12, but which could be a variety of articles of manufacture. The heat exchanger assembly 10 includes locations for attachments 13, 14, 15, and 16 for attaching a first component shown as a first heat exchanger 11 to a second component shown as a second heat exchanger 12. The affixing means includes attachment combinations 17 18 19 20 with features for engaging tabs or fingers or ledge or locator post on heat exchanger 11 and heat exchanger 12. The skilled artisan shall appreciate, however, that a variety of components of various articles of manufacture may be attached with the attachment described herein.

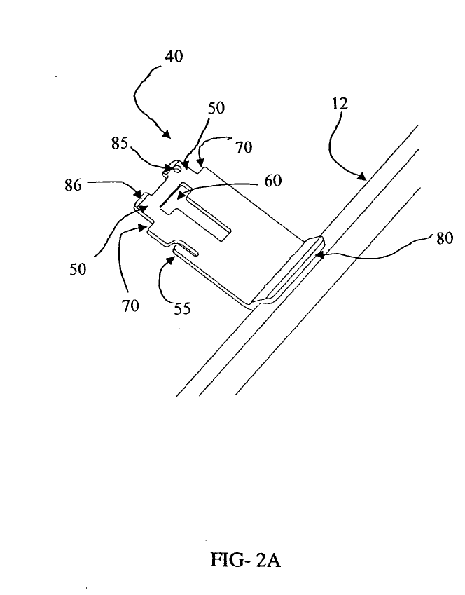

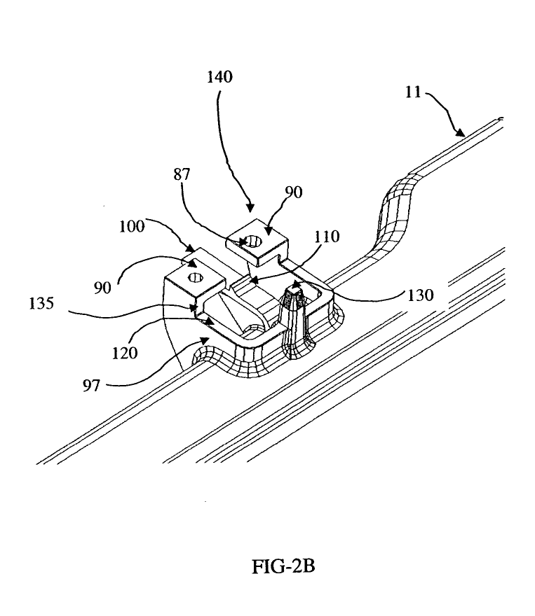

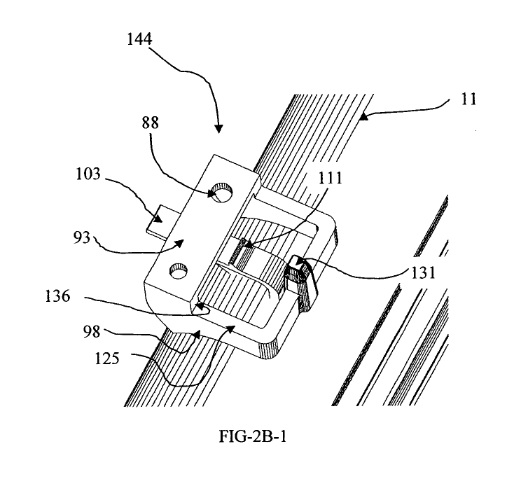

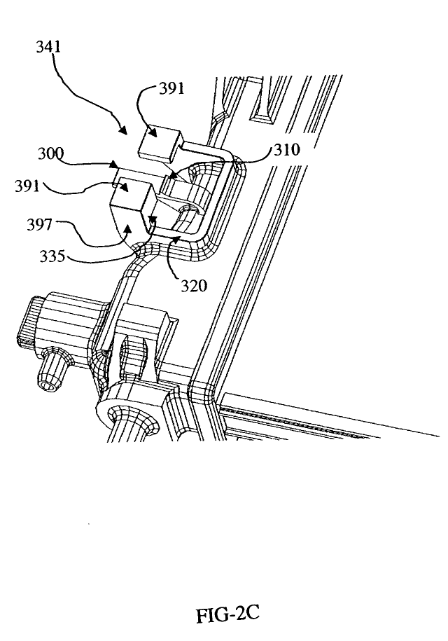

Referring to FIGS. 2a and 2b shows affixing means 40 and 140, affixing means 40 includes a bracket 40 including an opening 60 for a snap affixing means for engaging heat exchanger to heat exchanger, a tab portion 80 to assist in sliding during assembly, portions 50 to engage with heat exchanger tabs 90 which are positioned on slot wall 97, locator post 130 to provide target for bracket opening 60 and take vertical loads, combinations of stop edges 70 and 135 prevent over travel of sliding heat exchanger, snap ledge 110 formed integrally on flex finger or bayonet 100 which snaps to opening 60, a hole 85 and 87 as backup if integral features are damages during the life, stop wall 120 preventing overflexing of bayonet 100 and a tapered leading edge 86 allowing smooth engagement with slot tab 90. Product quality feedback in the assembly process is provided by error proofing feature 55.

Referring to FIGS. 2a and 2b-1 shows affixing means 40 and 144, as in FIGS. 2a and 2b above, having no slot tab, but including a slot continuous flange 93.

Referring to FIGS. 2a and 2c shows affixing means 40 and 341, affixing means 40 includes a bracket 40 including an opening 60 for a snap affixing means for engaging heat exchanger to heat exchanger, a tab portion 80 to assist in sliding during assembly, portions 50 to engage with slot tabs 391 which are on slot wall 397, a combination of stop edges 70 and 335 to prevent over travel of sliding heat exchanger, snap ledge 310 formed integrally on flex finger or bayonet 300 which snaps to opening 60, stop wall 320 preventing overflexing of bayonet 300 and a tapered leading edge 86 allowing smooth engagement with slot tab 391.

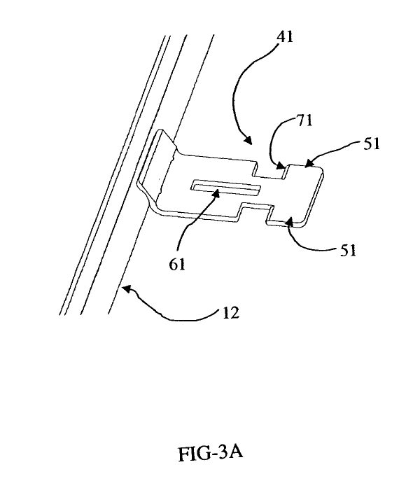

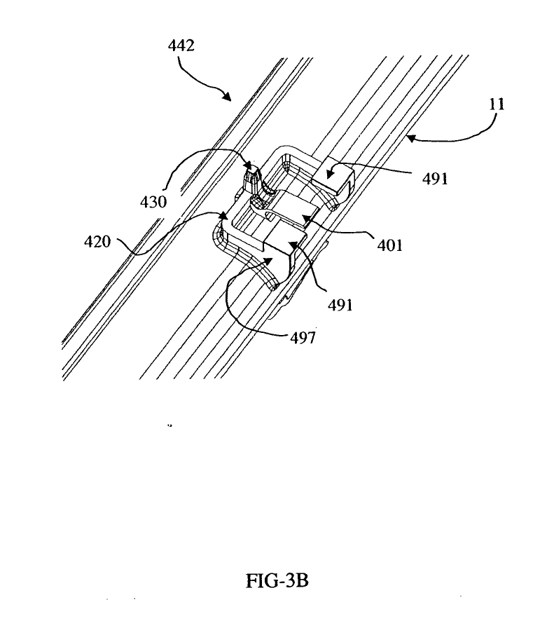

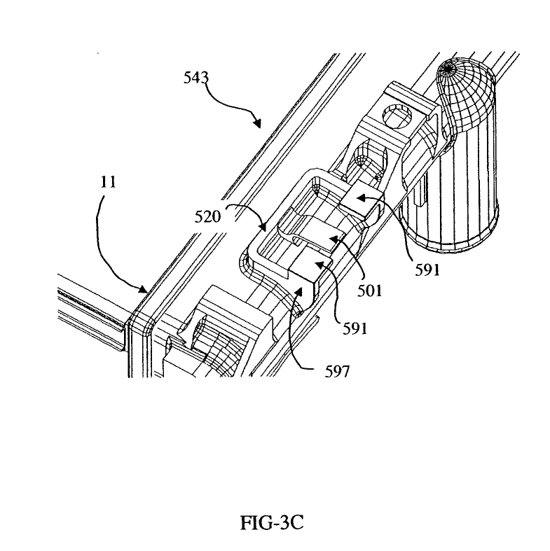

Referring to FIGS. 3a and 3b shows affixing means 41 and 442, affixing means 41 includes a bracket 41 including an opening 61 for affixing means for locating heat exchanger 12 to heat exchanger 11 and carrying load, locator post 430 to provide target for bracket opening 61 and take vertical loads, portions 51 are used to engage with slot tabs 491 which are positioned on slot wall 497, stop wall 420 preventing over flexing of bayonet 401 and a tapered leading edge 71 allowing smooth engagement with slot tab 491.

Referring to FIGS. 3a and 3c shows affixing means 41 and 543, is same as described in above paragraph but without the use of a locator post 430.

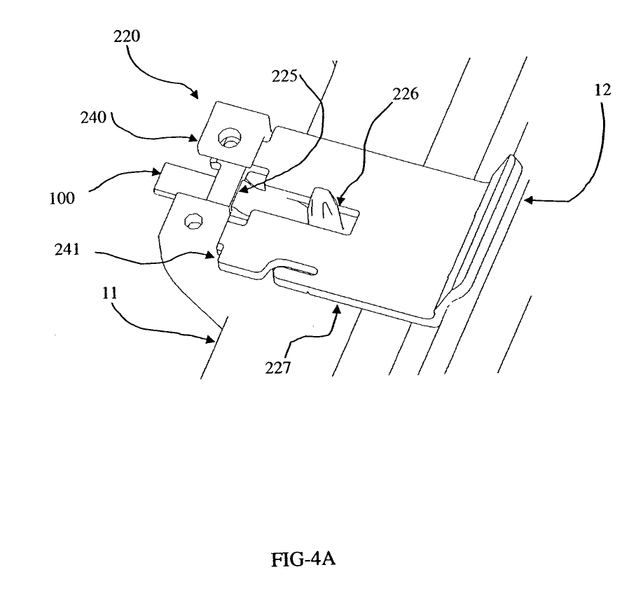

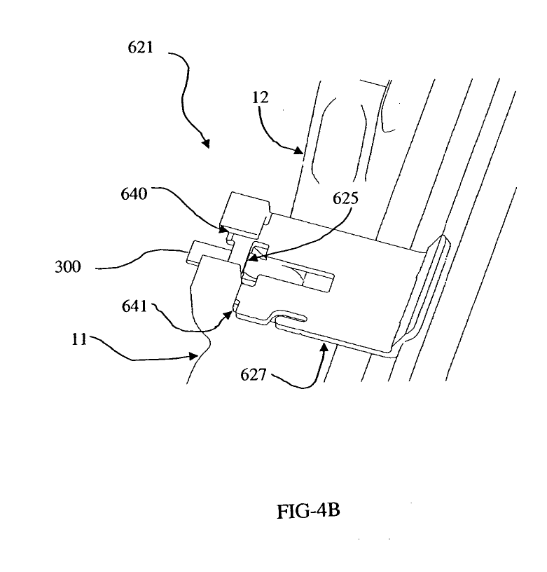

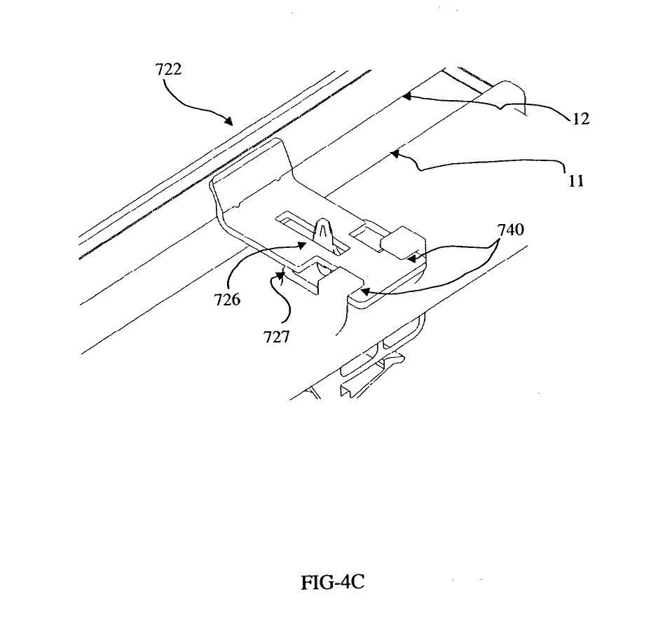

Referring to FIGS. 4a, 4b and 4c show the assembled position of above mentioned affixing means.

As an example location 13 can be as shown in the FIG. 4a in assembled position 220. The snapped attachment 225 prevents movement in one of the direction, preferably cross car or left to right direction, the portion 240 is fully captured flange by the slot tab or a continuous flange which prevents movement in one of the direction, preferably vehicle front or back movement, engagement 226 of locator post and opening in the bracket prevents movement in at least one direction, preferably vehicle vertical direction movements. Engagement 241 created by stop edges prevents movement in one of the directions, preferably remaining cross car movement and engagement 227, which is between the flange and slot wall prevents movement in one of the direction, preferably remaining forward or backward movement. This creates a snapped attachment combination restricting the movement between two components. This creates restriction in at least 6 directions.

As an example location 14 can be as shown in the FIG. 4b in assembled position 621. The snapped attachment 625 prevents movement in one of the direction, preferably cross car or left to right direction, the portion 640 is captured or fully captured flange by the slot tab or continuous flange which prevents movement in one of the direction, preferably vehicle front or back movement. Engagement 641 created by stop edges prevents movement in one of the direction, preferably remaining cross car movement preferably to prevent further sliding of heat exchanger and engagement 627 which is, between the flange and slot wall prevents movement in one if the direction, preferably remaining forward or backward movement. This creates a snapped attachment combination restricting the movement between two components. This creates a snapped attachment combination restricting movement in at least 4 directions.

As an example location 15 can be as shown in the FIG. 4c in assembled position 722. The portion 740 is captured or fully captured flange by the slot tab or continuous flange which prevents movement in one of the direction, preferably vehicle front or back movement, the engagement 727 which is between flange and stop wall prevent movement in one of the direction preferably in the remaining vehicle front or back direction, engagement 726 of locator post to opening in the bracket engagement prevents movement in at least one direction, preferably vehicle vertical direction movements. The bayonet or flex finger without snapping ledge creates a preload on the flange to prevent any looseness in the system. This creates an attachment combination restricting the movement between two components. This creates a snapped attachment combination restricting movement in at least 4 directions.

As an example location 16 can be envisioned same as shown in FIG. 4c in assembled position 722 but without a locator post. This creates an attachment combination restricting the movement between two components in at least 2 directions.

Of course, it is contemplated that attachments according to the present invention may allow motion as well as motion. Moreover, various larger or smaller tolerances may be formed between openings, flanges, flanged portions, flange members, protrusions or any other components to restrict or allow motion as desired. In preferred embodiments, attachments according to the present invention restrict motion to a minimum level.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A heat exchanger assembly, comprising:
A first attachment component including slot wall, slot tab, a flexible member, stop wall, and a stop edge combination;
a second attachment component, including a mating bracket with flange combination
wherein the first attachment component is approximately parallel to the second attachment component and wherein the bracket is aligned with the opening formed by the slot walls of the first attachment component.

2. A heat exchanger assembly as in claim 1 wherein one or more attachment components have at least one back up hole for screws.

3. A heat exchanger assembly as in claim 1, wherein the one of the attachment component includes an alignment element.

4. A heat exchanger assembly as in claim 1, wherein the first attachment component and second attachment component are assembled using a sliding motion.

5. A heat exchanger assembly as in claim 1, wherein the first attachment component and second attachment component once assembled restrict movement in at least 2 directions.

6. A heat exchanger assembly as in claim 1, wherein the first attachment component and second attachment component once assembled restrict movement in at least 4 directions.

7. A heat exchanger assembly as in claim 2, wherein the first attachment component flexible member includes a snapping ledge.

8. A heat exchanger assembly as in claim 2, wherein the bracket is aligned with the alignment element of the first heat exchanger component.

9. A heat exchanger assembly as in claim 1, wherein the flange of the second attachment component is fully captured under the slot tab of the first attachment component.

10. A heat exchanger assembly as in claim 1, wherein one or more of the attachment components engage another component by snapping in.

11. A heat exchanger assembly as in claim 2, wherein the alignment element is a post or locator post.

12. A heat exchanger assembly, as in claim 9, wherein two or more of the attachment components engage other components by snapping in.

13. A heat exchanger assembly comprising:
a first attachment component including slot wall, slot tab, a flexible member, an alignment element, a stop wall, and a stop edge combination;
wherein the first attachment component is approximately parallel to the second attachment component and wherein the bracket is aligned with the open area formed by the slot wall or the alignment element, of the first heat exchanger component and assembled using a sliding motion.

14. A heat exchanger assembly as in claim 13 wherein one or more attachment components have at least one back up hole for screws.

15. A heat exchanger assembly as in claim 13, wherein the first attachment component and second attachment component once assembled restrict movement in at least 2 directions.

16. A heat exchanger assembly as in claim 15, wherein the first attachment component and second attachment component once assembled restrict movement in at least 4 directions.

17. A heat exchanger assembly as in claim 1 wherein the slot tabs are continuous.

18. An assembly comprising:
A first attachment component including slot wall, slot tab, a flexible member, stop wall, and a stop edge combination;
a second attachment component, including a mating bracket with flange combination; wherein the first attachment component and the second attachment component are assembled using a sliding motion and wherein the components, once assembled, restrict movement in at least 2 directions.
